(19) United States
(12) Patent Application Publication
(10) Pub. No.: US 2014/0331771 A1
(43) Pub. Date: Nov. 13, 2014

(54) Ultrasonic Measurement System

(71) Applicant: Hitachi-GE Nuclear Energy, Ltd., Hitachi-shi (JP)

(72) Inventors: Atsushi BABA, Tokyo (JP); Yoshinori MUSHA, Tokyo (JP); Atsushi FUSHIMI, Tokyo (JP)

(73) Assignee: Hitachi-GE Nuclear Energy, Ltd., Hitachi-shi (JP)

(21) Appl. No.: 14/081,598

(22) Filed: Nov. 15, 2013

(30) Foreign Application Priority Data
Nov. 26, 2012 (JP) 2012-257652

(51) Int. Cl. G01B 17/02; G01K 7/02

(52) U.S. Cl. CPC G01B 17/02; G01K 7/02
USPC 73/597

(57) ABSTRACT

Disclosed is an ultrasonic measurement system that even without additional means for temperature measurement, compensates for a change in a sound speed of an ultrasonic wave in a section whose thickness is to be measured, and assesses a wall thinning state of this section by highly accurate measurement of the thickness.

An ultrasonic transducer 101 includes a piezoelectric element 108. A high-temperature MI cable 102 contains strands 110A, 110B connected to the ultrasonic transducer 101, and further includes a metallic sheath 112. A temperature sensor is contained in the high-temperature MI cable 102, and includes a thermocouple section 114 to which the strands 110A, 110B are connected at one end of each strand. An ultrasonic transmitter/receiver 117 makes the ultrasonic transducer to transmit ultrasonic waves and to receive the waves reflected from the object whose thickness is to be measured. A temperature-measuring instrument 115 uses the temperature sensor to measure temperature of the object 106 whose thickness is to be measured. A signal logger 104 corrects the sound speed of the ultrasonic wave propagating through the object whose thickness is to be measured, by use of information on the temperature measured by the temperature-measuring instrument 115, and then measures the thickness of the object 106.

### BACKGROUND OF THE INVENTION

1. Field of the Invention

The present invention relates generally to ultrasonic measurement systems that monitor for pipe wall thinning in nuclear power plants and various other plants in service. The invention more particularly relates to a temperature-compensated ultrasonic measurement system.

2. Description of the Related Art

In electric power plants, members estimated to become hot while the power plant is in service have traditionally been inspected to assess the healthiness of each member during routine plant inspection either by lowering the temperature of a section to be inspected, to an executable level of the inspection, or in anticipation of a decrease in the temperature. For example for the inspection, a visual inspection and an eddy-current inspection are performed as a surface inspection which is intended to assess the healthiness of the member surface, while an ultrasonic inspection is performed as a volumetric inspection which is intended to assess the healthiness of the inside, backside and underside of the member and check for wall thinning, cracking and fissuring. With such plants as mentioned above, a demand for continuous monitoring of the plants healthiness under the high temperature in service are increasing, to maintain existing old power plants, to improve inspection efficiency, and to enhance plant availability.

The ultrasonic inspection in conventional routine plant inspection uses single-element ultrasonic sensors each including one piezoelectric element, to inspect pipelines for wall thinning or to inspect members of a simple shape. During the manufacture of these ultrasonic sensors, either a piezoelectric element formed from a piezoelectric material of a single crystal, or a composite element formed from a thin, cylindrical piezoelectric element solidified with an epoxy resin is fixed to a resin plate, called a front faceplate, by bonding with an epoxy adhesive. In addition, a large majority of these sensors are assigned a backing material to brake the piezoelectric element and control a wave number, and this backing material, as with the above, is usually composed primarily of an epoxy resin. For these reasons, conventional ultrasonic sensors commonly use an epoxy adhesive or resin and further use polyimide or the like as the front faceplate, so these sensors can only withstand temperatures not more than nearly 80° C. as their maximum normal working temperatures. Above this temperature level, the epoxy adhesive or resin suffers thermal damage, which then causes the separation of the bonded surface and results in an ultrasonic signal transmitting/receiving failure.

In order to overcome this disadvantage, so-called high-temperature ultrasonic transducers, in which ultrasonic sensors has higher heat resistance, are proposed to monitor for in-service plant pipe wall thinning and other undesirable events (for example, JP-1993-11042-A, JP-2005-64919-A, and JP-2005-308691-A).

Of these high-temperature ultrasonic transducers, the one proposed in JP-1993-11042-A uses SiC-based and Si₃N₄-based ceramic as a front faceplate, and has PbNb₂O₆-based and PbTiO₃-based piezoelectric transducers joined together to the front faceplate via a solder, thereby forming an ultrasonic probe useable at high temperatures around 250° C.

In addition, the transducer proposed in JP-2005-64919-A is a high-temperature ultrasonic probe constructed with a piezoelectric element of a flat-plate-shaped lithium niobate single crystal tightly attached to an electrically conductive base via a highly heat-resistant soft metal, which is a flat plate formed from gold, silver, copper, aluminum, or an alloy thereof.

Furthermore, the transducer proposed in JP-2005-308691-A is an ultrasonic probe for a high-temperature member. This ultrasonic probe is formed using the following method. That is to say, a metal plate made of either a stainless steel material or a titanium material or a carbon steel material is joined to an ultrasonic signal transmitting/receiving side of the piezoelectric transducer made from either of lithium niobate and lead niobate, via a eutectic zinc-aluminum-based solder alloy. A portion sealed off with a highly heat-resistant organic adhesive, which includes a high-density metal powder formed from either tungsten or a tungsten oxide, or with a highly heat-resistant inorganic adhesive, is formed on a rear side of the piezoelectric transducer.

If any one of the high-temperature ultrasonic transducers proposed in JP-1993-11042-A, JP-2005-64919-A, and JP-2005-308691-A is only used alone, however, in-service monitoring for pipe wall thinning in an electric power plant is difficult to achieve. This is because the sound speed of ultrasonic waves has temperature dependence in the metallic material(s) used in the pipeline(s) of the power plant.

As described in “Highly Accurate and Continuous Monitoring for Wall Thinning under High Temperature (IIC REVIE/2009/10, No. 42)”, for example, in the soft steel used as a pipe material, sound speed generally has temperature dependence as shown in FIG. 4 of the document, and is known to change by about 4.8% between normal temperature and 400° C. To measure thickness of a desired section, therefore, the change in sound speed with temperature needs to be corrected using any other appropriate means such as providing a thermocouple.

### SUMMARY OF THE INVENTION

To perform appropriate corrections according to temperature, it is necessary that a temperature sensor be mounted on the target section and that a cable for the temperature sensor be laid between the temperature sensor and a signal-processing device provided to acquire a signal from the sensor. If the section whose thickness is to be measured is a pipe provided in the power plant, since this section and the signal-processing device are usually distant from each other, the cable for the temperature sensor needs to be laid as additional means for temperature measurement. In this case, the temperature sensor will usually be mounted at a location exposed to a high-temperature environment and narrow, confined with many pieces of equipment, including heat-insulated pipelines. Therefore, it will also take a great deal of time and labor to add the temperature sensor cable as well as to mount the temperature sensor.

An object of the present invention is to provide an ultrasonic measurement system that even without additional means for temperature measurement, compensates for a change in a sound speed of an ultrasonic wave in a section whose thickness is to be measured, and assesses a wall thinning state of this section by highly accurate measurement of its thickness.

In order to attain the above object, an aspect of the present invention includes: an ultrasonic transducer with a piezoelectric element; a high-temperature MI (Mineral-Insulated) cable having a built-in strand connected to the ultrasonic transducer, the cable including a metallic sheath; a temperature sensor contained in the high-temperature MI cable; an ultrasonic transmitter/receiver that makes the ultrasonic transducer to transmit ultrasonic waves and to receive the waves reflected from an object whose thickness is to be measured; a temperature-measuring instrument using the temperature sensor to measure temperature of the object whose thickness is to be measured; and a signal logger configured to compensate for a change in a sound speed of an ultrasonic wave propagating through the object whose thickness is to be measured, by use of information on the temperature measured by the temperature-measuring instrument, and then measure the thickness of the object.

In this configuration, even if no additional means is provided for temperature measurement, the change in the sound speed of the ultrasonic wave in the section whose thickness is to be measured can be compensated for, and wall thinning of the section whose thickness is to be measured can be assessed by highly accurate measurement of the thickness.

In accordance with the present invention, even if no additional means is provided for temperature measurement, a change in the sound speed of an ultrasonic wave in the section whose thickness is to be measured can be compensated for, and wall thinning of the section whose thickness is to be measured can be assessed by highly accurate measurement of the thickness.

### BRIEF DESCRIPTION OF THE DRAWINGS

FIG. 1 is an overall block diagram of an ultrasonic measurement system according to a first embodiment of the present invention;

FIG. 2 is an enlarged cross-sectional view that shows essential elements of the ultrasonic measurement system according to the first embodiment of the present invention;

FIG. 3 is a diagram illustrating a time waveform of ultrasonic waves generated in the ultrasonic measurement system according to the first embodiment of the present invention;

FIG. 4 is a diagram that illustrates temperature dependence of sound speed in a metallic material used as an object to be monitored;

FIG. 5 is an overall block diagram of an ultrasonic measurement system according to a second embodiment of the present invention; and

FIG. 6 is an overall block diagram of an ultrasonic measurement system according to a third embodiment of the present invention.

### DESCRIPTION OF THE PREFERRED EMBODIMENTS

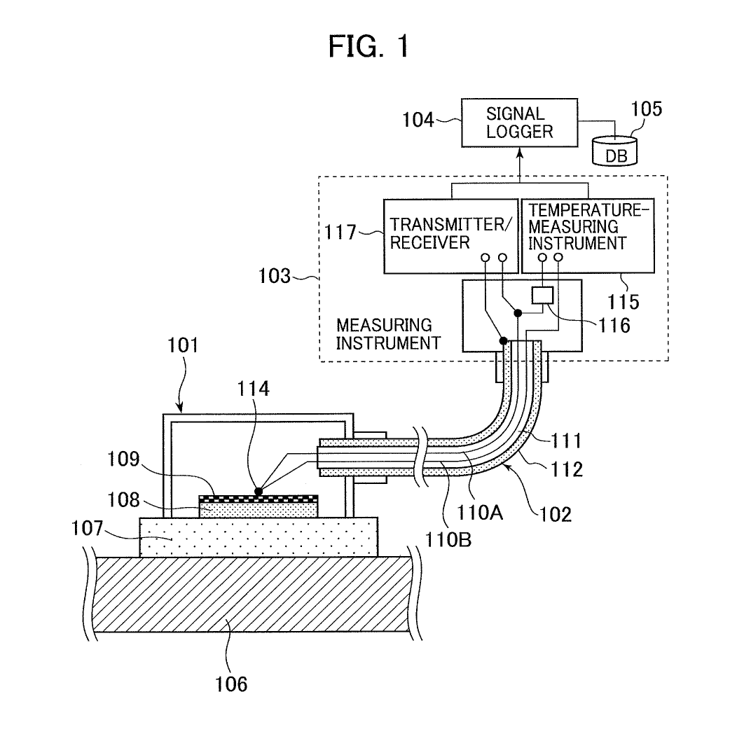

Hereunder, a configuration and operation of an ultrasonic measurement system according to a first embodiment of the present invention will be described using FIGS. 1 to 4.

First, an overall configuration of the ultrasonic measurement system according to the first embodiment of the present invention is described below using FIG. 1.

FIG. 1 is an overall block diagram of the ultrasonic measurement system according to the first embodiment of the present invention.

The ultrasonic measurement system of the present embodiment includes a high-temperature ultrasonic transducer 101, a high-temperature MI (Mineral-Insulated) cable 102, a measuring instrument 103, a signal logger 104, and a materials sound speed database 105.

The high-temperature ultrasonic transducer 101 is set up on an object 106 to be monitored, by use of a highly heat-resistant acoustic connecting method such as press-fitting a highly heat-resistant inorganic adhesive, a high-temperature solder, or a noble metal sheet. The object 106 to be monitored is, for example, a pipe as used in an electric power plant. The acoustic connecting methods mentioned above have an ability to withstand high temperatures around 200° C.

The high-temperature ultrasonic transducer 101 includes a transducer front faceplate 107 with a piezoelectric element 108 joined thereto. The transducer front faceplate 107 is formed from a metal comparable in linear expansion coefficient to the pipe to be monitored as the object 106 in the power plant, and the metal is, for example, stainless steel or an Inconel alloy. The piezoelectric element 108 is commonly made from a piezoelectric material, and more particularly, from a highly heat-resistant piezoelectric material having a Curie point of at least 200° C. Examples of these materials are lead titanate (PbTiO₃), lead zirconate titanate (Pb(Zrₓ, Ti₁₋ₓ)O₃), lithium niobate (LiNbO₃), potassium niobate (KNbO₃), bismuth titanate (Bi₄Ti₃O₁₂), gallium phosphate (GaPO₄), and compounds thereof. The material of the piezoelectric element 108 can be any of these materials.

An electrode section 109 is formed on the piezoelectric element 108. The electrode section 109 is formed from gold (Au), silver (Ag), platinum (Pt), nickel (Ni), or any other appropriate noble metal. The electrode section 109 may be formed using a generally known method that generally provides high heat resistance, high strength, and low electrical resistance, such as sputtering, vapor deposition, plating, or noble metal pasting.

The high-temperature MI cable 102 includes two strands 110A and 110B, an insulator 111, and a metallic protecting sheath 112. The insulator 111 is commonly made from an inorganic insulating material such as magnesia (MgO) or alumina (Al₂O₃). Stainless steel (e.g., SUS304 or SUS316) or a nickel-containing alloy (e.g., Inconel 600) is commonly used as the metallic protecting sheath 112. The strands 110A, 110B are a combination of strand materials that can be used to form a thermocouple. Commonly known combinations of strand materials include, for example, a combination of chromel and alumel, used to form a K-thermocouple, a combination of chromel and constantan, used to form an E-thermocouple, a combination of iron and constantan, used to form a J-thermocouple, a combination of nicrosil and nisil, used to form an N-thermocouple, and a combination of platinum rhodium and platinum, used to form an R-thermocouple. One of these materials may be selected that is appropriate for a temperature environment under which the object 106 is to be monitored. The strands of the high-temperature MI cable 102 that allow the formation of any such thermocouple may be electrically interconnected at one end of each strand, to form a thermocouple section 114. The thermocouple section 114 generates an electromotive force (DC current) of several microvolts to millivolts in response to a change in temperature of the thermocouple section. The thermocouple section 114 is electrically connected to the electrode section 109 on an upper surface of the piezoelectric element 108 by electrically conductive noble metal pasting, bonding with an adhesive, high-temperature soldering, or the like. Measuring the electromotive force of the thermocouple section 114 with the temperature-measuring instrument 115 contained in the measuring instrument 103 allows measuring of the temperature of the thermocouple section 114.

The present invention uses a protecting circuit 116 to reduce any impacts of a pulse signal used for ultrasonic wave measurement described later herein. The protecting circuit 116 only needs to be one composed to cut off or absorb either the pulse signal used in an ultrasonic transmitter/receiver 117, or a radio-frequency (RF) signal, and allow only the electromotive force (DC voltage) of the thermocouple section 114 that will be measured with the temperature-measuring instrument 115, to pass through the circuit 116. The protecting circuit 116 may be an analog type of low-pass filter, for example. The protecting circuit 116 may not necessarily be mounted if the temperature-measuring instrument 115 has a function equivalent to that of the protecting circuit or if the temperature-measuring instrument 115 and the ultrasonic transmitter/receiver 117 are synchronized to separate measurement timing in terms of time.

The ultrasonic transmitter/receiver 117 connects to one end of the metallic protecting sheath 112 of the high-temperature MI cable 102 to use as ground, and connects to one end of the strand 110A, which is one of the strands 110A, 110B, to use as a signal line. At this time, when the monitoring site and a location of the measuring instrument 103 are distant from each other, the ultrasonic transmitter/receiver 117 connects to the strand 110A, which is one of the strands 110A, 110B has a resistance value lower than that of the other, to allow for attenuation of the ultrasonic signal. As the strand 110A of a lower resistance value, either alumel in a K-thermocouple, constantan in an E-thermocouple, iron in a J-thermocouple, nisil in an N-thermocouple, or platinum in an R-thermocouple is connected.

The metallic protecting sheath 112 of the high-temperature MI cable 102 is connected at the other end of the sheath to a casing of the high-temperature ultrasonic transducer 101, and functions as ground for the piezoelectric element 108. No wiring is necessary if the casing of the high-temperature ultrasonic transducer 101 is made of an electrically conductive metal. If the casing is formed from a non-electroconductive material such as ceramic, however, the transducer front faceplate 107 and the metallic protecting sheath 112 of the high-temperature MI cable 102 need to be electrically interconnected inside or outside the high-temperature ultrasonic transducer 101 by wiring. This electrically grounds the piezoelectric element 108.

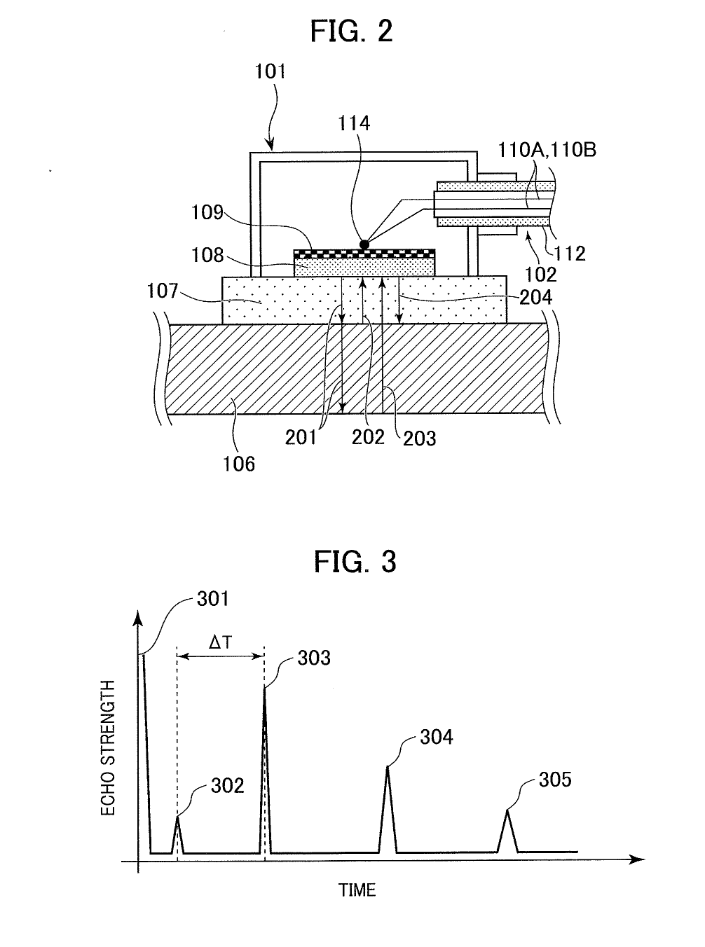

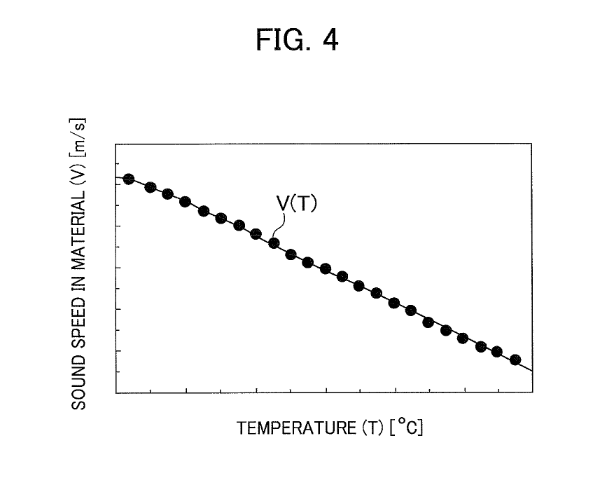

The ultrasonic transmitter/receiver 117 applies the pulse signal to the piezoelectric element 108 via the strand 110A of the high-temperature MI cable 102 and thus generates ultrasonic waves. These ultrasonic waves pass through the transducer front faceplate 107 and then propagate through the object 106 to be monitored. This operational sequence will be described later using FIG. 2. The ultrasonic transmitter/receiver 117 receives a time waveform of the ultrasonic waves via the strand 110A. A signal denoting the temperature of the thermocouple section 114 that the temperature-measuring instrument 115 has measured, and the time waveform of the ultrasonic waves that the ultrasonic transmitter/receiver 117 has received are output to and logged in the signal logger 104. Thickness of the object 106 to be monitored is assessed using the temperature signal and the receive waveform of the ultrasonic waves, and information saved in the materials sound speed database 105. Details will be described later herein using FIGS. 3 and 4.

In this way, the high-temperature MI cable 102 in the present embodiment is connected between the high-temperature ultrasonic transducer 101 installed at the monitoring site, and the location of the measuring instrument 103 that is distant from the monitoring site. The high-temperature MI cable 102 contains the two strands, 110A and 110B, that are electrically interconnected at one end of each strand to constitute a thermocouple section and to function as a temperature sensor. Installing the ultrasonic transducer 101 at the site, therefore, also allows placement of the temperature sensor, eliminates necessity for placement of an additional element for the temperature sensor, and enables temperature measurement of a desired section without providing additional means for the temperature measurement. Consequently, a change in the speed of sound in the section whose thickness is to be measured can be compensated for and wall thinning of this section can be assessed by highly accurate measurement of its thickness.

In addition, the high-temperature MI cable 102 includes the two strands, these two strands being used for the temperature measurement. In addition, one strand and the metallic protecting sheath 112 of the MI cable 102 can be used for ultrasonic measurement. That is to say, at least one of the two strands is used for both ultrasonic measurement and the temperature measurement, so the number of strands in the cable can be reduced.

Next, measuring principles of the ultrasonic measurement system according to the present embodiment are described below using FIGS. 2 to 4.

FIG. 2 is an enlarged cross-sectional view that shows essential elements of the ultrasonic measurement system according to the first embodiment of the present invention. The same reference numbers as in FIG. 1 denote the same elements.

FIG. 2 shows in enlarged view the high-temperature ultrasonic transducer 101 and monitoring target 106 (the object to be monitored) as installed. An ultrasonic wave 201 that has transmitted using the pulse signal applied to the piezoelectric element 108 passes through the transducer front faceplate 107 and then part of the ultrasonic wave becomes a reflected wave 202 at an interface between the transducer front faceplate 107 and the object 106 to be monitored. Description of this reflected wave at the interface is omitted hereinafter for the sake of simplicity in the description of the present embodiment.

An ultrasonic wave that has passed through the interface between the transducer front faceplate 107 and the object 106 to be monitored is reflected by a base of the object 106 and becomes a reflected wave 203. The reflected wave 203 reaches the piezoelectric element 108 and becomes an electrical signal (RF signal) with an oscillation as a receive ultrasonic signal. Part of the reflected wave 203 is once again reflected by the interface of the piezoelectric element 108 and the transducer front faceplate 107, and becomes a reflected wave 204. In this way, substantially the same operational sequence will be repeated until the reflected ultrasonic waves have lost their strength.

The ultrasonic transmitter/receiver 117 shown in FIG. 1 logs a time waveform of the ultrasonic waves generated during the above multiple-reflection sequence.

Next, the time waveform of the ultrasonic waves due to the above multiple-reflection sequence is described below using FIG. 3.

FIG. 3 is a diagram illustrating the time waveform of the ultrasonic waves generated in the ultrasonic measurement system according to the first embodiment of the present invention.

For the sake of simplicity, the time waveform (RF signal) of the ultrasonic waves is shown as an echo strength waveform in FIG. 3. As shown, the pulse signal 301 is generated prior to the transmission of the ultrasonic waves; an echo signal 302 is the reflected wave at the interface between the transducer front faceplate 107 and the object 106 to be monitored; an echo signal 303 is the reflection from the base of the object 106; and echo signals 304 and 305 are multiple-reflection signals of the echo signal 303. Here, prior to the thickness assessment of the object 106 to be monitored, a time difference Δt between the occurrence times of the echo signals 302 and 303 is calculated and then thickness is calculated by multiplication of the sound speed in the material. The thickness of the object 106 is denoted by expression (1) as follows:

L=V(T)xΔt/2 (1)

where L is the thickness of the object 106 to be monitored, V(T) is the speed at which sound propagates through the material at a temperature T, and Δt is the time difference between the occurrence times of the echo signals 302 and 303.

The temperature dependence of sound speed in a metallic material used as the object to be monitored is described below using FIG. 4.

FIG. 4 is a diagram that illustrates the temperature dependence of sound speed in the metallic material used as the object to be monitored.

If the object 106 to be monitored is a metallic material, it is known that the sound speed in this material has the temperature dependence shown in FIG. 4. Shown in FIG. 4 is the temperature dependence of sound speed in a steel material, the sound speed decreasing as temperature increases. The sound speed V(T) in the material is calculated using the temperature that was measured with the temperature-measuring instrument 115 shown in FIG. 1, and the thickness of the object 106 to be monitored can be managed with the temperature value of the measured section and measured with high accuracy.

The sound speed V(T) in the material, shown in FIG. 4, is saved in the materials sound speed database 105 shown in FIG. 1. The sound speed V(T) saved in the materials sound speed database 105 may only be previously acquired data or may be the temperature data and sound speed data acquired in an initial state free from wall thinning, such as during startup of plant operation or during a start of an increase in temperature.

As described above, even if the object 106 to be monitored suffers insignificant wall thinning, the ultrasonic measurement system according to the present embodiment assesses the thickness of the monitoring target with high accuracy by compensating for a change in the sound speed in the material, thus confirms healthiness of the plant, and contributes to improving safety.

As described above, in the ultrasonic measurement system of the present embodiment, two strands of the high-temperature MI cable with the metallic sheath useable to form a thermocouple are electrically connected at one end of each of the two strands to the piezoelectric element within the high-temperature ultrasonic transducer. In this state, the temperature of the high-temperature ultrasonic transducer is measured by the temperature-measuring instrument.

In addition, the ultrasonic transmitter/receiver is connected to one of the MI cable strands that has a lower resistance value. In this state, one strand and the metallic sheath function as ground when ultrasonic measurements are conducted.

Furthermore, the ultrasonic measurement system obtains the ultrasonic-wave receive signal and the temperature value of the section whose thickness is to be measured. The system refers to information on the speed of sound in the material whose thickness is to be measured, from a previously created materials sound speed database, thereby compensating for a change in the receive signal of the ultrasonic waves in the section whose thickness is to be measured. Thus, even if the temperature of the section whose thickness is to be measured changes during plant operation, the receive signal of the ultrasonic waves is compensated with respect to the temperature. This allows highly accurate assessment of the thickness of the intended section.

Additionally, since temperature measurement and ultrasonic measurement can be executed using one high-temperature MI cable, there is no need to provide second temperature-measuring means. Thus, even if the section whose thickness is to be measured is placed in a high-temperature and narrow, confined environment, the high-temperature ultrasonic transducer and the cable are simple and easy to install and route, respectively. This enhances system applicability to different sites and contributes to maintenance of various power plants.

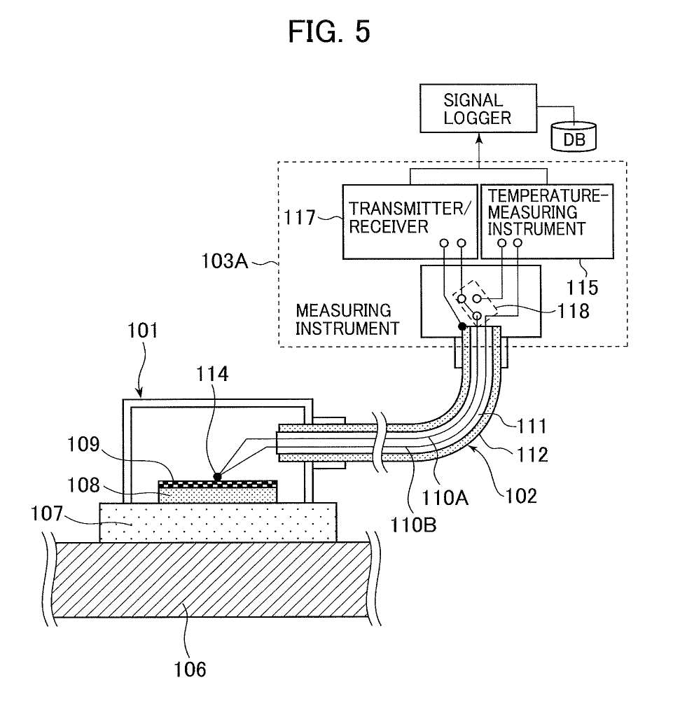

Next, a configuration and operation of an ultrasonic measurement system according to a second embodiment of the present invention is described below using FIG. 5.

FIG. 5 is an overall block diagram of the ultrasonic measurement system according to the second embodiment of the present invention. The same reference numbers as in FIG. 1 denote the same elements.

The ultrasonic measurement system of the present embodiment differs from that of the first embodiment shown in FIG. 1, in that a measuring instrument 103A contains a signal switcher 118, not the protecting circuit 116.

Prior to measurement, the signal switcher 118 switches the pulse signal or the RF signal used in the ultrasonic transmitter/receiver 117, to the electromotive force (DC voltage) generated in the thermocouple section 114 which conducts measurements using the temperature-measuring instrument 115, or vice versa. Use of the signal switcher 118 allows independent acquisition of each signal. A method of assessing the thickness of the object to be monitored is substantially the same as in the first embodiment.

In the present embodiment, even if the temperature of the section whose thickness is to be measured changes during plant operation, the receive signal of the ultrasonic waves can also be temperature-compensated and the thickness of the section whose thickness is to be measured can be assessed with high accuracy.

Additionally, since temperature measurement and ultrasonic measurement can be executed using one high-temperature MI cable, there is no need to provide second temperature-measuring means. Thus, even if the section whose thickness is to be measured is placed in a high-temperature and narrow, confined environment, the high-temperature ultrasonic transducer and the cable are simple and easy to install and route, respectively. This enhances system applicability to different sites and contributes to maintenance of various power plants.

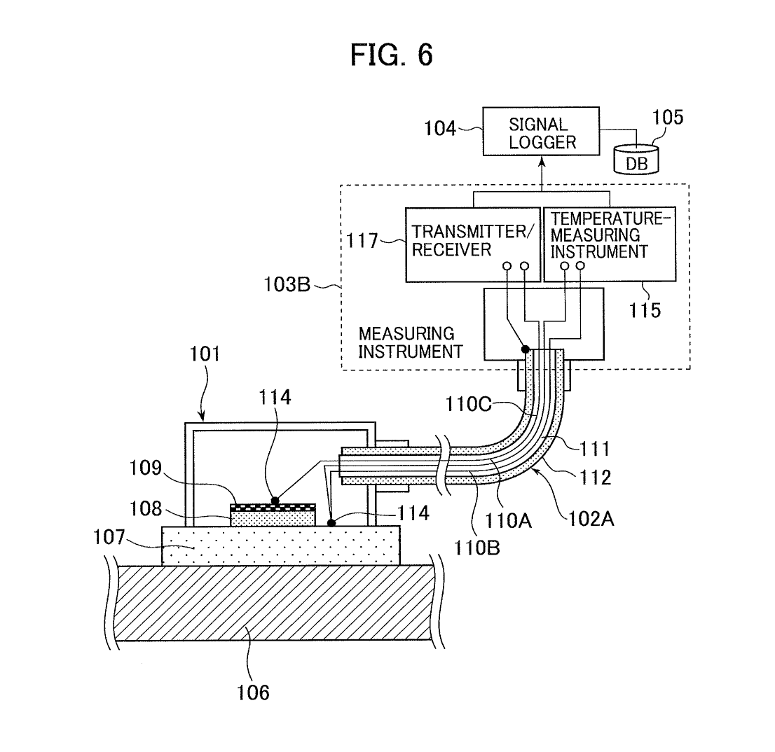

Next, a configuration and operation of an ultrasonic measurement system according to a third embodiment of the present invention is described below using FIG. 6.

FIG. 6 is an overall block diagram of the ultrasonic measurement system according to the third embodiment of the present invention. The same reference numbers as in FIG. 1 denote the same elements.

The ultrasonic measurement system of the present embodiment differs from that of the first embodiment shown in FIG. 1, in that the system uses a composite high-temperature MI cable 102A. The high-temperature MI cable 102A differs from the high-temperature MI cable 102 in that in addition to the combination of strands 110A, 110B useable to constitute a thermocouple as shown in FIG. 1, the cable has a third strand 110C connected at one end thereof to the ultrasonic transmitter/receiver 117. The strand 110C is formed from a material, such as gold (Au), silver (Ag), platinum (Pt), or nickel (Ni), that has a low resistance value and reduces an attenuation level of the pulse signal used for ultrasonic measurement, and the strand is electrically connected at the other end thereof to the electrode section 109 on the piezoelectric element 108.

This makes unnecessary the protecting circuit 116 shown in the first embodiment, and the signal switcher 118 shown in the second embodiment. In this case, the thermocouple section formed by electrically interconnecting one end of each of two strands is not fixed to the electrode section 108 on the piezoelectric element 108. Instead, the thermocouple section is fixed to, for example, the transducer front faceplate 107 or any other position at which the thermocouple becomes less susceptible to an impact of the pulse signal, associated with the transmission and reception of ultrasonic waves. Thus, ultrasonic measurement and temperature measurement suffer substantially no influence of each other and can each be conducted without signal switching. The thickness of the object to be monitored can therefore be assessed in substantially the same way as in the first embodiment.

In the present embodiment, even if the temperature of the section whose thickness is to be measured changes during plant operation, the receive signal of the ultrasonic waves can also be temperature-compensated and the thickness of the section whose thickness is to be measured can be assessed with high accuracy.

Additionally, since temperature measurement and ultrasonic measurement can be executed using one high-temperature MI cable, there is no need to provide second temperature-measuring means. Thus, even if the section whose thickness is to be measured is placed in a high-temperature and narrow, confined environment, the high-temperature ultrasonic transducer and the cable are simple and easy to install and route, respectively. This enhances system applicability to different sites and contributes to maintenance of various power plants.

What is claimed is:

1. An ultrasonic measurement system comprising:
an ultrasonic transducer with a piezoelectric element;
a high-temperature MI cable having a built-in strand connected to the ultrasonic transducer, the cable including a metallic sheath;
a temperature sensor contained in the high-temperature MI cable;
an ultrasonic transmitter/receiver that makes the ultrasonic transducer to transmit ultrasonic waves and to receive the waves reflected from an object whose thickness is to be measured;
a temperature-measuring instrument using the temperature sensor to measure temperature of the object whose thickness is to be measured; and
a signal logger configured to compensate for a change in a sound speed of an ultrasonic wave propagating through the object whose thickness is to be measured, by use of information on the temperature measured by the temperature-measuring instrument, and then measure the thickness of the object.

2. The ultrasonic measurement system according to claim 1, wherein:
the high-temperature MI cable has a first strand and a second strand,
the first strand and the second strand are joined together at one end of each strand to constitute a thermocouple section,
ultrasonic measurements are conducted via the first strand and the metallic sheath, and
a protecting circuit is provided to cut off an ultrasonic-wave measuring signal and allow only an electromotive force generated by the thermocouple section, to pass through the circuit.

3. The ultrasonic measurement system according to claim 1, wherein:
the high-temperature MI cable has a first strand and a second strand,
the first strand and the second strand are joined together at one end of each strand to constitute a thermocouple section,
ultrasonic measurements are conducted via the first strand and the metallic sheath; and
a signal switcher is provided to switch an ultrasonic-wave measuring signal to an electromotive force generated by the thermocouple section, and vice versa.

4. The ultrasonic measurement system according to claim 2, wherein:
the first strand has a resistance value lower than that of the second strand.

5. The ultrasonic measurement system according to claim 1, wherein:
the high-temperature MI cable has a first strand, a second strand, and a third strand;
the first strand and the second strand are joined together at one end of each strand to constitute a thermocouple section; and
ultrasonic measurements are conducted via the third strand and the metallic sheath.
